(19) United States
(12) Patent Application Publication
(10) Pub. No.: US 2024/0121216 A1
(43) Pub. Date: Apr. 11, 2024

(54) APPLICATION SHARING BETWEEN PRIVATE NETWORKS

(71) Applicant: DISH Wireless L.L.C., Englewood, CO (US)

(72) Inventors: Jennings Maxwell Orcutt, Denver, CO (US); Robyn Skyler-Lott Casias, Morrison, CO (US)

(21) Appl. No.: 18/378,961

(22) Filed: Oct. 11, 2023

Related U.S. Application Data
(60) Provisional application No. 63/415,124, filed on Oct. 11, 2022.

(51) Int. Cl. H04L 9/40

(52) U.S. Cl. CPC H04L 63/0272

(57) ABSTRACT

This disclosure relates to wireless communication. In some aspects, a method includes receiving, at one or more computing devices from a first private network, information representing at least one application to be accessed by a user device associated with a second private network, the information representing the at least one application being configured in accordance with network parameters of the first private network; transmitting the information representing the at least one application to the user device in the form of information packets configured in accordance with network parameters of the second private network; and executing a smart contract representing application sharing agreements between the first private network and the second private network, wherein executing the smart contract includes recording a transaction in accordance with the application sharing agreements, the transaction representing the sharing of the at least one application.

### CROSS-REFERENCE TO RELATED APPLICATION

This application claims the benefit of U.S. Provisional Application No. 63/415,124, filed Oct. 11, 2022, the contents of which are incorporated by reference herein.

### TECHNICAL FIELD

This specification generally relates to wireless communication.

### BACKGROUND

A private network can be designed, for example, for enterprises to interconnect devices in accordance with the policies and protocols of the respective enterprises. Examples of such enterprises include companies, schools, governmental agencies, and other entities. The private network can provide the connectivity using wireless communication technologies, such as 4G and 5G technology. A private network can support the services/functions of a corresponding enterprise, for example, by providing secure and reliable connectivity that operates based on specific requirements imposed/implemented by the enterprise. In some implementations, to provide high security and data privacy, a private network can be configured such that only authenticated devices and/or users are able to access the private network. Different private networks can have different requirements, provide different services, and use different protocols.

### SUMMARY

In one aspect, this document describes a method that includes receiving, at one or more computing devices from a first private network, information representing at least one application to be accessed by a user device associated with a second private network, the information representing the at least one application being configured in accordance with network parameters of the first private network; transmitting the information representing the at least one application to the user device in the form of information packets configured in accordance with network parameters of the second private network; and executing a smart contract representing application sharing agreements between the first private network and the second private network, wherein executing the smart contract includes recording a transaction in accordance with the application sharing agreements, the transaction representing the sharing of the at least one application.

Other embodiments of this aspect include corresponding computer systems, apparatus, computer program products, and computer programs recorded on one or more computer storage devices, each configured to perform the actions of the method. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations, the method can include enabling a settlement between the first private network and the second private network through the executing of the smart contract.

In some implementations, the method can further include generating a proposal for application sharing between the first and second private networks.

In some implementations, the smart contract can be generated based on the proposal for application sharing.

In some implementations, information related to executing the smart contract can be exchanged through a permissioned smart contract channel.

In some implementations, the first private network can have a first requirement for security and transport of information packets, and the second private network can have a second requirement for security and transport of information packets.

In one aspect, this document describes a method that includes receiving, at one or more computing devices, a first information packet from a first private network, wherein a destination of the first information packet is a second private network, wherein the first private network and the second private network differ with respect to at least one network parameter such that the first information packet is incompatible with the second private network; converting the first information packet to a second information packet that accounts for the incompatibility with respect to the at least one network parameter such that the second information packet is decodable at the second private network; and routing the second information packet to the second private network.

Other embodiments of this aspect include corresponding computer systems, apparatus, computer program products, and computer programs recorded on one or more computer storage devices, each configured to perform the actions of the method. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations, each of the first and second information packets can be one of a data packet or a voice packet.

In some implementations, converting the first information packet to the second information packet can include wrapping the first information packet with information that allows a roaming session between the first and second private networks.

In some implementations, the first private network can have a first requirement for security and transport of information packets, the second private network can have a second requirement for security and transport of information packets.

In some implementations, the first information packet can be in a first format that is consistent with the first requirement, the second information packet can be in a second format that is consistent with the second requirement.

In some implementations, the method can further include executing a smart contract representing roaming agreements between the first private network and the second private network, wherein executing the smart contract can include recording a transaction in accordance with the roaming agreements, the transaction representing the routing of transmission.

In one aspect, this document describes a method that includes receiving, at one or more computing devices, one or more data packets to or from a private network; obtaining, based on the one or more data packets, information indicative of one or more requirements of the private network for supporting an operation associated with the one or more data packets; configuring one or more Internet services parameters based on the requirements of the private network; and routing the data packet in accordance with the one or more Internet services parameter.

Other embodiments of this aspect include corresponding computer systems, apparatus, computer program products, and computer programs recorded on one or more computer storage devices, each configured to perform the actions of the method. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations, the one or more Internet services parameters can include at least one of a download throughput or an upload throughput.

In some implementations, the one or more Internet services parameters can include at least one parameter that affects a latency associated with the private network.

In some implementations, configuring the one or more Internet services parameters can include changing, by the one or more computing devices, at least one operating parameter of a radio access network (RAN) device.

In some implementations, configuring the one or more Internet services parameters can include adjusting a signal strength of the RAN device.

In one aspect, this document describes a method that includes receiving, at one or more computing devices, one or more information packets from a first private network; determining, based on information included in the one or more information packets, one or more routes to deliver the one or more information packets to a second private network, wherein the one or more routes are determined based on routing criteria associated with routing information packets between the first and second private networks; and dispatching the one or more information packets to be routed through at least one of the determined routes.

Other embodiments of this aspect include corresponding computer systems, apparatus, computer program products, and computer programs recorded on one or more computer storage devices, each configured to perform the actions of the method. A system of one or more computers can be configured to perform particular operations or actions by virtue of having software, firmware, hardware, or a combination of them installed on the system that in operation causes or cause the system to perform the actions. One or more computer programs can be configured to perform particular operations or actions by virtue of including instructions that, when executed by data processing apparatus, cause the apparatus to perform the actions.

The foregoing and other embodiments can each optionally include one or more of the following features, alone or in combination. In some implementations, the routing criteria can be based on a service level agreement (SLA) between the first private network and the second private network.

In some implementations, the routing criteria can be based on a target Quality-of-Service (QoS) parameter associated with routing information packets between the first and second private networks.

In some implementations, the QoS parameter can include at least one of: latency, transport cost, distance traveled, or network congestion level.

In some implementations, the routing criteria can specify a set of nodes to avoid in transmitting information packets from the first private network to a second private network.

In some implementations, the method can further include: accessing a list of potential routes that may be used to route information packets between the first and second private networks; and selecting the one or more roues from the list of potential routes based on the routing criteria associated with routing information packets between the first and second private networks.

Particular implementations of the subject matter described in this disclosure can be implemented so as to realize one or more of the following advantages.

The technology described herein can provide connectivity between different private networks and allow reliable, stable, and secure network connections and services for private networks. The technology described herein can provide various services for different private networks, and satisfy different requirements of the different private networks. The technology described herein can provide the different services in secure and private manner. The technology described herein can support automatic settlement for the services using smart contract.

It is appreciated that methods and systems in accordance with the present disclosure can include various combinations of the aspects and features described herein. That is, methods and systems in accordance with the present disclosure are not limited to the combinations of aspects and features specifically described herein, but also may include other combinations of the aspects and features provided.

The details of one or more implementations of the present disclosure are set forth in the accompanying drawings and the description below. Other features and advantages of the present disclosure will be apparent from the description and drawings, and from the claims.

### BRIEF DESCRIPTION OF DRAWINGS

FIG. 1 is a block diagram of an example environment for providing private network interconnect protocol exchange (PN-IPX) for private networks.

FIG. 2 is a flow diagram of an example process for providing private network interconnect protocol exchange (PN-IPX) for private networks.

FIG. 3A is a block diagram of an example environment for providing private network global roaming exchange (PN-GRX) for private networks.

FIG. 3B is a block diagram of another example environment for providing private network global roaming exchange (PN-GRX) for private networks.

FIG. 4 is a flow diagram of an example process for providing global roaming exchange (PN-GRX) for private networks.

FIG. 5 is a block diagram of an example environment for providing private network application service exchange (PN-ASX) for private networks.

FIG. 6 is a flow diagram of an example process for providing private network application service exchange (PN-ASX) for private networks.

FIG. 7 is a block diagram of an example environment for providing private network voice service exchange (PN-VSX) for private networks.

FIG. 8 is a flow diagram of an example process for providing private network voice service exchange (PN-VSX) for private networks.

FIG. 9 is a block diagram of an example environment for private network Internet service exchange (PN-ISX) for private networks.

FIG. 10 is a flow diagram of an example process for providing Internet services for private networks using private network Internet service exchange (PN-ISX).

FIG. 11 illustrates block diagrams of example computing devices.

### DETAILED DESCRIPTION

Private networks are designed for enterprises, institutions and other organizations to interconnect member devices in accordance with custom protocols, security requirements, policies etc. Due to the vary nature and purpose of private networks, two different private networks can differ with respect to one or more network parameters, security protocols, policies etc. —which can lead to incompatibility issues when two or more private networks are communicating with one another. Yet, often, secure and predictable communications between private networks are of paramount importance. For example, when private networks corresponding to two government entities or hospitals are communicating with one another, it is important to provide secure, predictable, and reliable interconnection mechanisms to handle communications among such networks. The technology described herein allows for such communications among private networks, and/or communications between a private network and a public network such as the Internet.

For example, this document describes technology for exchanging information packets (e.g., data, voice) between two private networks while accounting for inconsistencies and incompatibilities in parameters, protocols, and/or other network configurations between the two private networks. In some implementations, the technology described herein can provide a private network interconnect protocol exchange (PN-IPX) that connects different private networks around the globe. The PN-IPX can be configured to manage information packets between pairs of private networks such that the PN-IPX intercepts information packets originating from one private network to another, and makes adjustments to the information packet such that the adjusted information packet is compatible with the second private network. In some implementations, the technology described herein can provide a private network voice service exchange (PN-VSX) that acts as an intermediary device that provides voice routing services among private networks.

This document also describes technology that allows for a device to seamlessly roam from one private network on to another (or from a private network to a public network). For example, the technology described herein can provide a private global roaming exchange (PN-GRX) that can be configured to allowing devices to roam from one private network to another without interrupting secure sessions on the devices. This can entail, for example, intercepting information packets from a session initiated on a private network and adjusting the packets in to be compatible with a roaming session on the

The document further describes technology for adjusting Internet services based on specific needs of a particular private network. For example, if a private network includes multiple security cameras that are uploading video streams to a cloud storage, Internet services parameters such as upload speed may need to be adjusted to support such large-scale uploads. In some implementation, the technology described herein can provide a private network Internet service exchange (PN-ISX) that can be configured to curate Internet access for private networks.

In addition, this document describes technology that allows for sharing one or more applications among two or more private networks, and updating a smart contract automatically to keep track of such sharing. In some implementations, the technology described herein can provide a private network application service exchange (PN-ASX) that acts as a service provider allowing the private networks to interconnect with each other and set up private network application sharing.

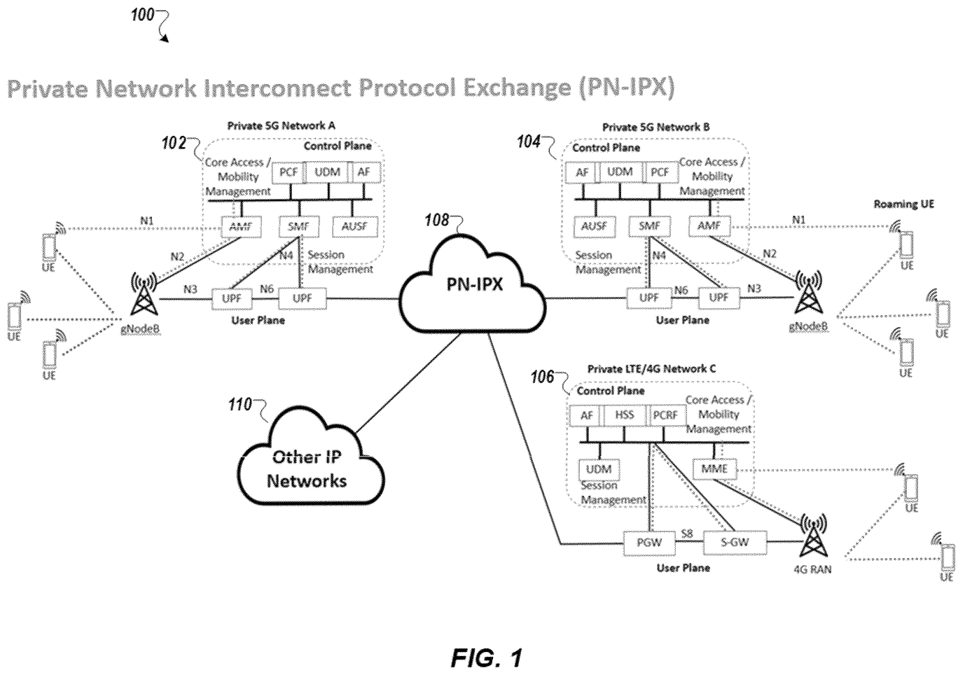

FIG. 1 is a block diagram of an example environment 100 for providing private network interconnect protocol exchange (PN-IPX) for private networks. The example environment 100 includes a first private network, e.g., private 5G Network A 102; a second private 5G Network B 104, and a third private LTE/4G Network C 106.

Each private network 102-106 can belong to a different enterprise or organization. For example, private 5G Network A can belong to Enterprise A. Private 5G network B can belong to Enterprise B. Private Long-Term Evolution/4G (LTE/4G) network can belong to Enterprise C. The services and protocols for each private network 102-106 can be different. Each private network 102-106 can have its own base station (e.g., gNodeB stations for private 5G networks) and other communication infrastructures. Each private network 102-106 can have its own users and user equipment (UE) that are authenticated to access the private network. The private networks 102-106 can be mobile private networks, or fixed private networks.

A 5G private network can include a combination of a 5G private network control plane and a 5G user plane. The 5G control plane can include one or more of: application function (AF) modules, unified data management (UDM) modules, policy control function (PCF) modules, authentication server function (AUSF) modules, session management function (SMF) modules, access and mobility management function (AMF) modules, or other control plane modules of a 5G network. The 5G user plane can include a combination of multiple user-plane function (UPF) modules. The 5G control plane and user plane modules can be configured to communicate with 5G RAN resources such as a gNodeB.

A private LTE/4G network can include a combination of an LTE/4G control plane and an LTE/4G user plane. The 4G control plane can include, for example, one or more of LTE/4G AF modules, home subscriber server (HSS) modules, policy and charging rule functions (PCRF) modules, UDMs, or mobility management entities (MME). The LTE/4G user plane can include, for example, a packet-data-network (PDN) gateway (PGW) and a server gateway (SGW). The LTE/4G control plane and user plane modules can be configured to communicate with LTE/4G RAN resources.

In some implementations, the private network interconnect protocol exchange (PN-IPX) 108 can be configured to connect different private networks around the globe. The PN-IPX 108 can include one or more computing devices. For example, the PN-IPX 108 can be a private network of multiple devices that facilitates interconnection of other private networks, such as 5G and LTE private networks. The PN-IPX 108 can allow the private networks to share radio, core network functions and user plane resources geographically around the globe.

The PN-IPX 108 can be a private network interconnection model for the exchange of traffic, e.g., Internet protocol based traffic (IP-based traffic) between devices of separate private networks 102-106. In some implementations, the PN-IPX 108 can exchange traffic for various types of service provider, such as Internet service provider, via IP based network-to-network interface.

The PN-IPX 108 can provide IP interconnect for private networks 102-106, e.g., 5G and LTE private networks as a service. The PN-IPX 108 can include satellite, fiber, transport devices, and other telecommunication infrastructures that facilitate the communication between private networks 102-106. Each private network 102-106 can connect with the PN-IPX 108 through an entry point. While the example of FIG. 1 shows the PN-IPX deployed at a location external to the private networks, in some implementations, the PN-IPX may be deployed within a private network.

The PN-IPX 108 can provide routing capabilities for the traffic from one private network to another private network. The PN-IPX 108 can provide the routing capability for different types of traffics. The PN-IPX 108 can provide connectivity for different functions of the private networks 102-106. For example, if user plane function (UPF) of private 5G Network A 102 needs to communicate with the UPF of private 5G Network B 104, the PN-IPX 108 can set up connectivity and route the UPF packets from private 5G Network A 102 to private 5G Network B 104 in a secure and private manner. For example, the PN-IPX can be configured to receive data packet from one private network, and route the data packets to another private network via one or more paths selected based on one or more routing criteria. In some implementations, a path/route can be selected based on the path being one that corresponds to the least resistance/bottleneck, latency, transport cost, distance traveled etc. Such routing can be highly ‘relevant for private network, for example, due to quality of service (QoS) issues, service level agreements (SLA) etc. For example, in some cases, it may be highly important for data of a certain type to be routed to a destination within a particular time limit. In such cases, the PN-IPX 108 can be configured to select a route (potentially adaptively) that is least likely to be congested and/or most likely to deliver information packets to destination.

In some implementations, the PN-IPX 108 can have access to a roster of paths that may be available for routing data packets from one private network to another, together with labels indicative of usability/priority of the corresponding path for specific purposes. For example, paths that use nodes physically located at hostile geographical areas may be avoided for sensitive data to reduce possibility of data breach. In another example, paths that can potentially result in high latency may be avoided for time-sensitive information such as that carried by voice packets.

In some implementations, the PN-IPX 108 can receive requirements from each private network 102-106 and adjust the configuration of the connection between any pair of private networks based on the requirements. The requirements from a private network can include security requirements and transport requirements of data packets. For example, the security requirement can include requirements for privacy, access control, authentication, encryption, and the like. The transport requirements can include requirements for routing protocols (e.g., IPv6, IPv4), data sharing and data storing protocols, such as InterPlanetary File System (IPFS), data application layer protocols, communication method (e.g., fiber or wireless), and the like.

The PN-IPX 108 can adjust and repurpose the connection between any pair of private networks to satisfy the requirements of the private networks. For example, the PN-IPX 108 can receive a first data packet from a first private network, wherein the data packet is to be sent to a second private network. Because the first private network and the second private network have different requirements, the first private network and the second private network can be incompatible with respect to at least one network parameter such that the first data packet is incompatible with the second private network. The PN-IPX 108 can convert the first data packet to a second data packet that accounts for the incompatibility with respect to the at least one network parameter such that the second data packet is decodable at the second private network. For example, if one private network is a 3G network and the other is a 5G network, without more, voice packets from the 3G network would not be recognized by the 5G network and vice versa. In this example, the PN-IPX 108 can be configured to convert a voice packet originating from the 5G network into a form recognized by the 3G network. Likewise, a voice packet from the 3G network is also converted by the PN-IPX into a 5G compatible form that is decodable by the 5G network.

The PN-IPX 108 can provide connections for various layer, various security protocols, and various transport protocols of private networks around the world. The connections provided by the PN-IPX 108 can be secure, reliable, scalable, and customized to individual private network's requirements. In some implementations, the PN-IPX 108 can connect with other IP networks 110.

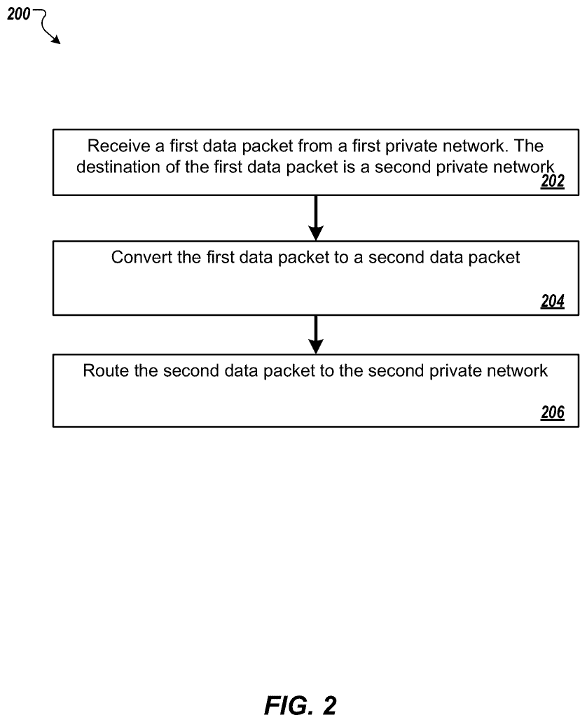

FIG. 2 is a flow diagram of an example process 200 for providing private network interconnect protocol exchange (PN-IPX) for private networks.

At step 202, the PN-IPX receives a first data packet from a first private network. The destination of the first data packet is a second private network. The first private network and the second private network are incompatible with respect to at least one network parameter such that the first data packet is incompatible with the second private network. The first private network and the second private can have different requirements and execute on different protocols. The first private network and the second private network can be incompatible with respect at least one network parameter, such as the routing protocols (e.g., IPv6, IPv4). The first data packet generated in the first private network may be incompatible with the second private network. For example, the first data packet may not be decoded at the second private network.

At step 204, the PN-IPX can convert the first data packet to a second data packet that accounts for the incompatibility with respect to the at least one network parameter such that the second data packet is decodable at the second private network. In some implementations, the PN-IPX obtains first requirements of the first private network and second requirements of the second private network. The requirements of each private network can include security requirements and transport requirements of the corresponding private network.

The PN-IPX can convert the first data packet to the second data packet to account for the incompatibility with respect to the at least one network parameter using the first and second requirements. The first data packet can be in a first format that is consistent with the requirements of the first private network. The second data packet can be in a second format that is consistent with the second requirements of the second private network. The PN-IPX can convert the first data packet into the second data packet based on the destination private network's requirements, such that the second data packet is decodable at the second private network. By converting the data packet, the PN-IPX can allow the data to be legible and executable on both ends.

At step 206, the PN-IPX can route the second data packet to the second private network. For example, the PN-IPX can route the second data packet to the second private network using a connection path established within the PN-IPX. The connection path can be established based on the transport requirements of the first private network and the second private network. For example, the connection path can be established for various layer, various security protocols, and various transport protocols of the first and second private networks.

The order of steps in the process 200 described above is illustrative only, and the process 200 can be performed in different orders. In some implementations, the process 200 can include additional steps, fewer steps, or some of the steps can be divided into multiple steps.

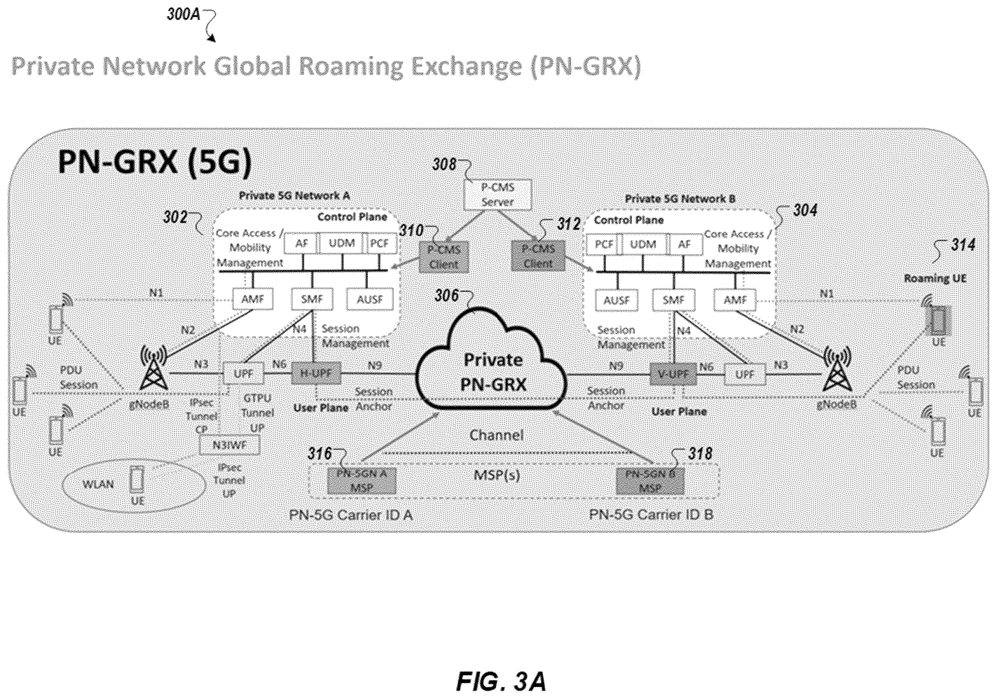

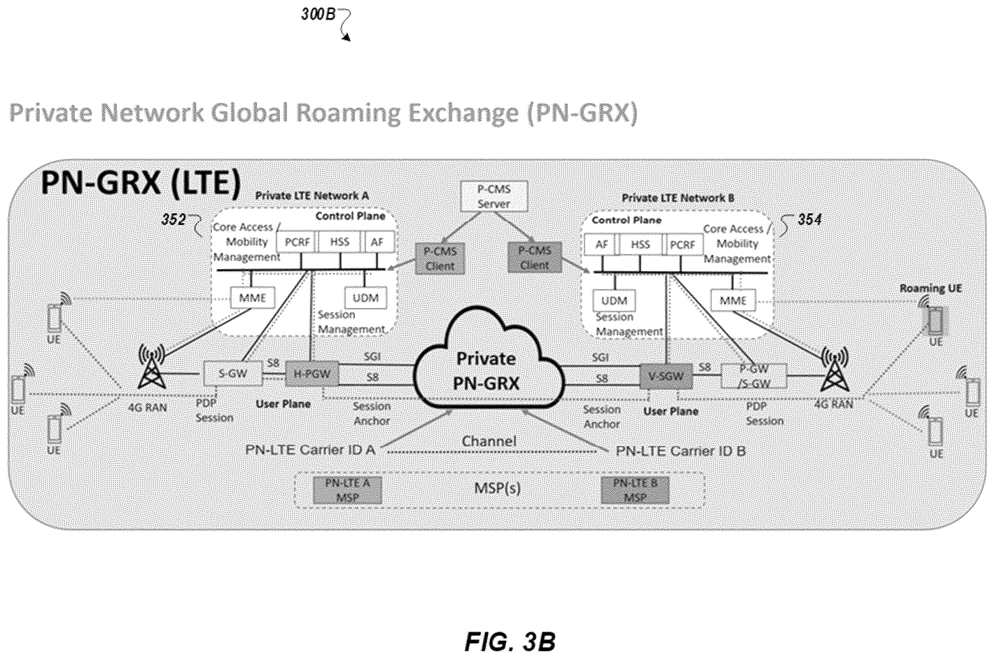

FIG. 3A is a block diagram of an example environment 300A for providing private network global roaming exchange (PN-GRX) for private networks. The example environment 300A includes a first private network, e.g., private 5G Network A 302; a second private network, e.g., private 5G Network B 304. Each private network 302, 304 can belong to a different enterprise or organization. For example, private 5G Network A can belong to Enterprise A. Private 5G network B can belong to Enterprise B. The services and protocols for each private network 302, 304 can be different. Each private network 302, 304 can have its own base station (e.g., gNodeB) and other communication infrastructures. Each private network 302, 304 can have its own users and user equipment (UE) that are authenticated to access the private network. In some implementations, the private 5G network A 302 can communicate with its UE in a wireless local-area network (WLAN) through non-3GPP-interworking function (N3IWF). The private networks 302, 304 can be mobile private networks, or fixed private networks. The PN-GRX 306 can include one or more computing devices.

The technology described herein can provide a private global roaming exchange (PN-GRX) 306 that acts as an authority allowing the private networks 302, 304 to interconnect with each other as roaming partners. The PN-GRX 306 can be stacked upon the PN-IPX described in FIGS. 1-2 or other IP interconnect, (direct, Public IPX) for 5G and LTE Private Networks to participate in PN-GRX roaming agreements. As discussed above, The PN-IPX can provide the connection between private networks. The PN-GRX 306 can provide the roaming exchange using the connection provided by PN-IPX. For the private networks that participate on PN-IPX, the PN-GRX 306 can allow the private networks to interconnect with each other as roaming partners without the need for any dedicated connections between them. For example, The PN-IPX provides IP interconnect for 5G and LTE private networks as service to participate in roaming agreements on the PN-GRX 306 or through direct agreements between private networks. The PN-GRX 306 acts as a hub for 5G and LTE private network interconnections for user equipment (UE) roaming between such different networks. For example, without more, a 3G session cannot roam on to 5G architecture. In such cases, the PN-GRX 306 can be configured to wrap/containerize the 3G/4G/LTE traffic to be recognized by an AMF of the 5G network. The PN-GRX 306 can be on a private or public IP backbone and transport private network roaming traffic between the visited and the home private network identities.

The PN-GRX 306 can allow the private networks to share radio, core network functions and user plane resources geographically around the globe. The PN-GRX 306 can provide the flexibility for private networks 302, 304 to setup private network roaming permissioned smart contract currency settlement agreements.

The PN-GRX private network roaming settlement agreements can leverage Global System for Mobile Communications Association (GSMA) introduced billing and charging evolution (BCE) specifications and smart contract roaming solution to set up smart contracts for roaming through the PN-GRX 306. The PN-GRX supported smart contract roaming solution can support functions for discovery, identity management, and billing settlement.

The PN-GRX 306 can leverage technologies such as detach transaction proposal or other, for private network contract management server (PN-CMS) 308 to generate a transaction proposal for roaming across private networks participating on the PN-GRX 306. In some implementations, the PN-CMS 308 is part of the PN-GRX 306. For example, the PN-CMS 308 can be a server that generates the rules, policies, or agreements for roaming service billing and charging. Based on such billing and charging policies/rules/agreements, a smart contract can be created. The users of private networks 302, 304 can be PN-CMS clients 310, 312 that use the roaming service. The private networks 302, 304 can agree to participate the PN-GRX 306 and sign the agreements, or deploy the smart contract.

The PN-CMS client 310 and 312 is a secure entry layer into the private network for provisioning contract roaming agreements when the smart contract is signed or deployed. When the smart contract is signed or deployed, the PN-CMS 308 can push the policies and rules to PN-CMS clients 310, 312 of the private networks 302, 304. The private networks 302, 304 can host such policies and rating rules. The private networks 302, 304 can rate the quality and quantity of the roaming services based on the policies/rules/roaming smart contract. For example, the private networks 302, 304 can determine the contract threshold for call duration, data usage, time and location of the provided roaming service. The private networks 302, 304 can determine the roamer's consumption based on the roaming UE's private network identity.

For example, user equipment (UE) 314 subscribed to private 5G Network A 302. The UE 314 roams into private 5G Network B 304. In this example, private 5G Network A 302 is the home private network. Private 5G Network B 304 is the visited private network. Private 5G Network B 304 can provide roaming service for UE 314 through the private PN-GRX 306. For example, Private 5G Network B 304 can establish a roaming session for the UE 314 and enable transmission for the UE 314. In some examples, the transmission is between the UE 314 and its home private network, private 5G Network A 302, over the private PN-GRX 306.

The visited private network, such as V-UPF, of private 5G Network B 304 can use the identity of the UE roaming session to enforce provisioned entitlements, policies, and rating rules on the home private network (H-PN) when roaming. Settlements can be paid through the PN-GRX 306 based on the provisioned network roaming entitlements for the roaming UE identities. The settlements can be in the form of cryptocurrency (e.g., bitcoin) or traditional currency (e.g., dollar, euro, and the like).

For example, as private 5G Network B 304 provides roaming service for UE 314 that is subscribed to private 5G Network A 302, the smart contract can be automatically triggered and executed. For example, based on executing the smart contract, a transaction can be recorded in accordance with the roaming agreement, the transaction representing the routing of transmission for the UE 314 in the roaming service. In some example, private 5G Network B 304 can automatically receive payment from private 5G Network A 302. The smart contract can define the rules for determining the amount of payment based on the attributes of the roaming service, such as the quality of the roaming service, the consumption of bandwidth, the roaming protocol, the time duration, the packet size of the transmission, and any other rules that are agreed between the home private 5G Network A 302 and the visited private 5G Network B 304.

In some implementations, the PN-GRX 306 can introduce the private network membership service permissions (PN-MSP) components 316, 318 as the mechanism to enable private networks to participate on PN-GRX permissioned smart contract channel. In some implementations, this allows contractual sharing of resources—such as roaming sessions, applications etc.—between private networks.

In some implementations, private 5G network PN-CMS allows for Wi-Fi integration for Roaming on the mobile core for non-3GPP InterWorking Function (untrusted) and Trusted WLAN Interworking Function (trusted).

FIG. 3B is a block diagram of another example environment 300B for providing private network global roaming exchange (PN-GRX) for private networks. Comparing to the example environment 300A in FIG. 3A, the example environment 300B includes two LTE private network, e.g., a first private network that is private LTE Network A 352; a second private network that is private LTE Network B 354.

While the examples above describe PN-GRX as a device that facilitates roaming between two private networks, the inventive concepts can also be applied to roaming between a private network and a public network. For example, a UE connected to a private network within an organization may roam to a public network for example when a user steps out of and away from a building within the organization. In such cases, the PN-GRX 306 can be configured to facilitate the roaming from the private network to a public network such that parameters associated with a session within the private network (e.g., security protocols) are maintained when the UE roams on to the public network.

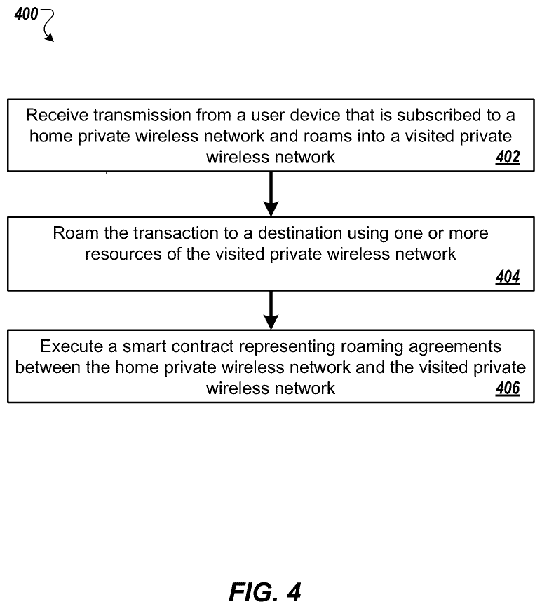

FIG. 4 is a flow diagram of an example process 400 for providing private network global roaming exchange (PN-GRX) for private networks.

At step 402, the PN-GRX can receive transmission from a user device that is subscribed to a home private wireless network and roams into a visited private wireless network. The PN-GRX can connect the home private wireless network and the visited private wireless network. The visited private wireless network provides roaming service for the user device. In some examples, using the roaming service the user device can access its home private network from the visited private network, over the PN-GRX.

At step 404, the PN-GRX can roam the transmission to a destination using one or more resources of the visited private wireless network. For example, the PN-GRX can perform the transmission between the home private network and the user device that roamed into the visited private network using the roaming session created by the visited private wireless network. The PN-GRX can perform the transmission in a secure and private manner.

At step 406, the PN-GRX execute a smart contract representing roaming agreements between the home private wireless network and the visited private wireless network. Executing the smart contract can include recording a transaction in accordance with the roaming agreements, the transaction representing the routing of the transmission. In some examples, a settlement between the home private wireless network and the visited private wireless network can be enabled through executing the smart contract supported by the PN-GRX. The smart contract can be automatically triggered and executed to enable the settlement. The smart contract is deployed by the home private wireless network and the visited private wireless network to support roaming service billing and charging. The smart contract can define the rules for determining the amount of payment based on the attributes of the roaming service. In some implementations, the payment is in the form of cryptocurrency. In some embodiments, the payment is in the form of traditional currency.

The order of steps in the process 400 described above is illustrative only, and the process 400 can be performed in different orders. In some implementations, the process 400 can include additional steps, fewer steps, or some of the steps can be divided into multiple steps.

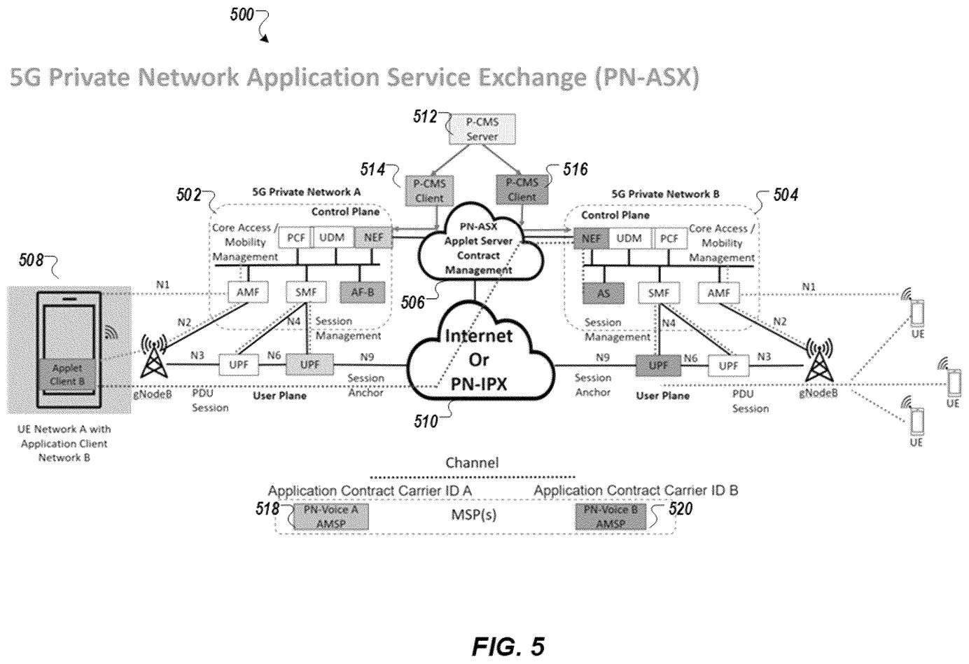

FIG. 5 is a block diagram of an example environment 500 for providing private network application service exchange (PN-ASX) for private networks. The example environment 500 can include two private networks, e.g., private 5G Network A 502 and private 5G Network B 504. Each private network 502, 504 can belong to a different enterprise or organization. For example, private 5G Network A 502 can belong to Enterprise A. Private 5G network B 504 can belong to Enterprise B. The services and protocols for each private network 502, 504 can be different. Each private network 502, 504 can have its own base station (e.g., gNodeB) and other communication infrastructures. Each private network 502, 504 can have its own users and user equipment (UE) that are authenticated to access the private network. The private networks 502, 504 can be mobile private networks, or fixed private networks. The PN-ASX 506 can include one or more computing devices.

The technology described herein can provide a private network application service exchange (PN-ASX) 506 that acts as an authority allowing the private networks 502, 504 to interconnect with each other and set up private network application sharing.

The PN-ASX 506 can facilitate a more efficient way for private networks (e.g., 5G private networks and LTE private networks) to interconnect devices of one private network (e.g., user device, user equipment) to private network applications of another private network. For example, UE 508 subscribed to 5G private network A 502 can be connected to the private network applications of 5G private network B 504, so that the UE 508 can share the applications of 5G private network B 504. For example, application functions and services hosted in one private network may be shared with another private network. The UE 508 can be connected to the control plane of 5G private network B 504 securely over the PN-ASX 506. The PN-ASX 506 facilitates private networks to share radio, core network functions and user plane resources geographically around the globe.

The PN-ASX 506 can allow UE or user devices of one private network to connect to the private network applications of another private network over dedicated connections, Internet or through the PN-IPX 510 (discussed in FIGS. 1-2) for sharing applications between private networks. In some implementations, the PN-ASX 506 can act as an authority providing private networks secure entry points between participating private networks 502, 504 sharing application functions. In some implementations, the PN-ASX 506 can provide the flexibility for the private networks to setup private network application sharing with permissioned smart contract currency settlement agreements. The PN-ASX 506 can provide the flexibility for private networks to setup private network application sharing with private settlement agreements between private network owners.

The PN-ASX 506 can support smart contract application exchange solution and provide support for private networks to include functions for data, voice discovery, identity management, and billing settlement.

The PN-ASX 506 can leverage technologies such as detach transaction proposal or other, for private network contract management server (PN-CMS) 512 to generate a transaction proposal for application sharing agreements across private networks participating on the PN-ASX 506. In some implementations, the PN-CMS 512 is part of the PN-GRX 506. For example, the PN-CMS 512 can be a server that generates the rules, policies, or agreements for application sharing service billing and charging. Based on such billing and charging policies/rules/agreements, a smart contract can be created. The users of private networks 502, 504 can be PN-CMS clients 514, 516 that use the application sharing service. The private networks 502, 504 can agree to participate the PN-ASX 506 and sign the agreements, or deploy the smart contract.

The PN-CMS client 514 and 516 is a secure entry layer into the private network for provisioning contract application exchange agreements when the smart contract is signed or deployed. When the smart contract is signed or deployed, the PN-CMS 512 can push the policies and rules to PN-CMS client 514 and 516 function of the private networks 502, 504 based on an application exchange membership between private networks 502, 504. The private networks 502, 504 can host such policies and rating rules. Each private network 502, 504 can host its own set of applications that can be shared with the other private network.

For example, 5G private network A 502 can have a first set of applications. 5G private network B 504 can have a second set of applications. UE belonging to 5G private network A 502 can share the applications of 5G private network B 504 using PN-ASX 506. UE belonging to 5G private network B 504 can share the applications of 5G private network A 502 using PN-ASX 506.

The private networks 502, 504 can rate the application sharing services based on the policies/rules/smart contract. For example, the private networks 502, 504 can determine the attributes of the shared application, such as the type, the popularity, and the functions of the shared application. The private networks 502, 504 can determine a payment for the application sharing service.

For example, user equipment (UE) 508 belongs to private 5G Network A 502. The UE 508 accesses the applications of private 5G Network B 504. Private 5G Network B 504 can provide application sharing service for UE 508 through the PN-ASX 506. As private 5G Network B 504 provides application sharing service for UE 508 that is subscribed to private 5G Network A 502, the smart contract can be automatically triggered and executed. For example, based on executing the smart contract, a transaction can be recorded in accordance with the application sharing agreement, the transaction representing the sharing of applications. In some example, private 5G Network B 504 can automatically receive payment from private 5G Network A 502. The payment can be in the form of cryptocurrency (e.g., bitcoin) or traditional currency (e.g., dollar, euro, and the like). The smart contract can define the rules for determining the amount of payment based on the attributes of the shared application, such as such as the type, the popularity, and the functions of the shared application, and any other rules that are agreed between the private 5G Network A 502 and the private 5G Network B 504.

In some implementations, the PN-ASX 506 can introduce the private network membership service permissions (PN-MSP) components 518, 520 as the mechanism to enable private network sharing through a permissioned smart contract channel.

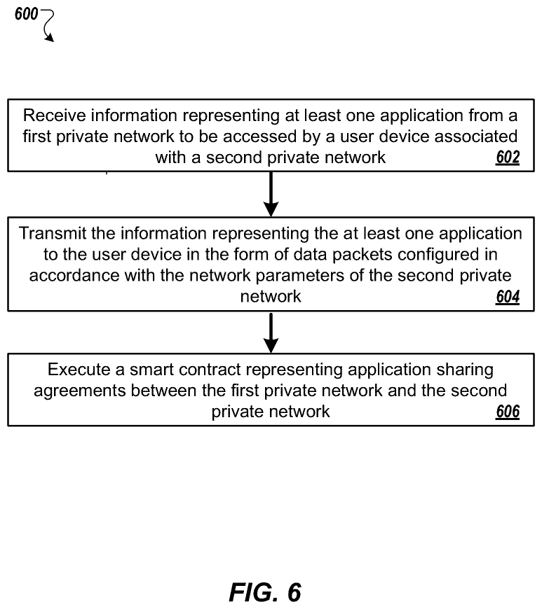

FIG. 6 is a flow diagram of an example process for providing private network application service exchange (PN-ASX) for private networks.

At step 602, the PN-ASX can receive information representing at least one application from a first private network to be accessed by a user device associated with a second private network. The information representing the at least one application can be configured in accordance with the network parameters of the first private network. The at least one application can be hosted on the first private network. The PN-ASX can connect the user device and the first private network. The first private network provides application sharing service for the user device, so that the user device can access the applications hosted on the first private network, over the PN-ASX.

At step 604, the PN-ASX can transmit the information representing the at least one application to the user device in the form of data packets configured in accordance with the network parameters of the second private network. To allow the user device subscribed to the second private network to use the at least one application of the first private network, the PN-ASX can configure the information representing the application in accordance with the network parameters of the second private network and transmit the information representing the application to the user device. The PN-ASX can transmit the information representing the application in a secure and private manner.

At step 606, the PN-ASX can execute a smart contract representing application sharing agreements between the first private network and the second private network. Executing the smart contract includes recording a transaction in accordance with the application sharing agreements, the transaction representing the sharing of the at least one application.

The PN-ASX can enable a settlement between the first private network and the second private network through the executing of the smart contract supported by the PN-ASX. The smart contract can be automatically triggered and executed to enable the settlement. The smart contract is deployed by the first private network and the second private network to support application sharing service billing and charging. The smart contract can define the rules for determining the amount of payment based on the attributes of the one or more shared applications. In some implementations, the payment is in the form of cryptocurrency. In some embodiments, the payment is in the form of traditional currency.

The order of steps in the process 600 described above is illustrative only, and the process 600 can be performed in different orders. In some implementations, the process 600 can include additional steps, fewer steps, or some of the steps can be divided into multiple steps.

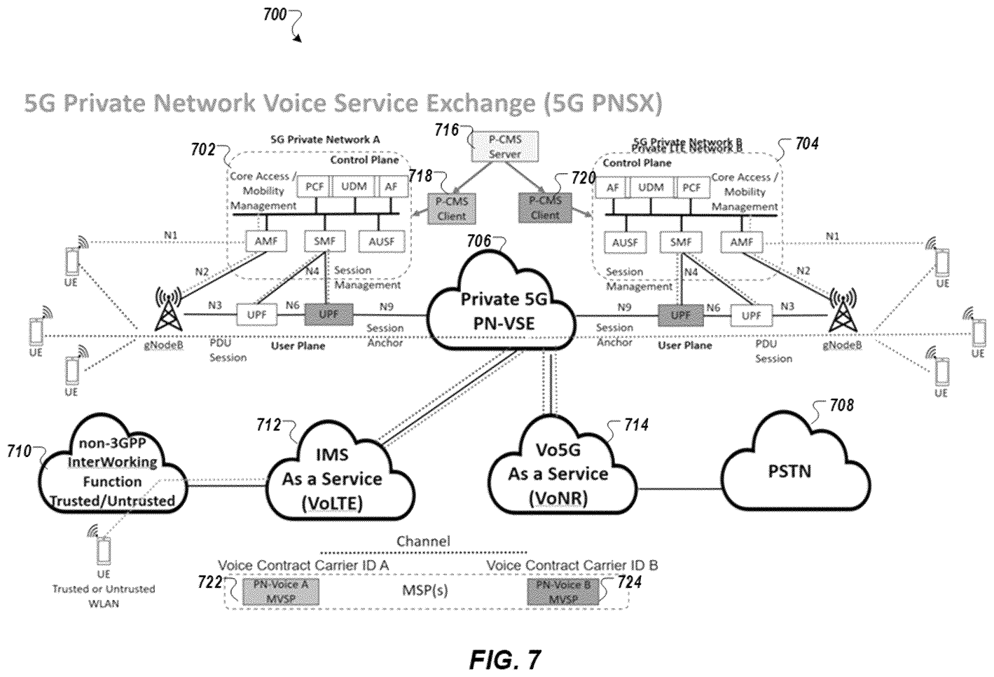

FIG. 7 is a block diagram of an example environment 700 for providing private network voice service exchange (PN-VSX) for private networks. The example environment 700 includes a first private network, e.g., private 5G Network A 702 a second private network, e.g., private 5G Network B or private LTE Network B 704. Each private network 702, 704 can belong to a different enterprise or organization. For example, private 5G Network A 702 can belong to Enterprise A. Private 5G network B 704 can belong to Enterprise B. The services and protocols for each private network 702, 704 can be different. Each private network 702, 704 can have its own base station (e.g., gNodeB) and other communication infrastructures. Each private network 702, 704 can have its own users and user equipment (UE) that are authenticated to access the private network. The private networks 702, 704 can be mobile private networks, or fixed private networks. The PN-VSX 706 can include one or more computing devices.

The technology described herein can provide a private network voice service exchange (PN-VSX) 706 that acts as an authority providing private networks 702, 704 an entry point for mobile originate (MO)/mobile terminal (MT) call voice routing services. The PN-VSX 706 allows private networks 702, 704 to participate on the PN-VSX 706 to interconnect with each other openly or through private voice exchange agreements.

In some implementations, the PN-VSX 706 can facilitate a more efficient way for private networks (e.g., 5G private networks and LTE private networks) 702, 704 connect with a common voice service exchange for routing calls between private networks 702, 704 and a public switched telephone network (PSTN) 708 geographically around the globe. The PN-VSX 706 acts as an authority service provider providing private networks 702, 704 an entry point for MO/MT voice call routing between participating private networks 702, 704 on the PN-VSX 706 to interconnect to the PSTN 708 as a service.

In some implementations, the PN-VSX 706 supports Wi-Fi integration into PN-VSX 706 for non-3GPP InterWorking Function (Untrusted & Trusted) 710 WLAN voice calling. In some implementations, the PN-VSX 706 supports IP multimedia subsystem (IMS) as a service 712 integrated into PN-VSX for voice calling. In some implementations, the PN-VSX 706 supports voice over 5G (Vo5G) as a service 714 integrated into PN-VSX for voice calling.

The PN-VSX 706 can support smart contract voice exchange solution and provide support for private networks to include functions for data, voice discovery, identity management, and billing settlement.

The PN-VSX 706 can leverage technologies such as detach transaction proposal or other, for private network contract management server (PN-CMS) 716 to generate a transaction proposal for voice agreements across private networks participating on the PN-VSX 706. In some implementations, the PN-CMS 716 is part of the PN-VRX 706. For example, the PN-CMS 716 can be a server that generates the rules, policies, or agreements for voice service billing and charging. Based on such billing and charging policies/rules/agreements, a smart contract can be created. The users of private networks 702, 704 can be PN-CMS clients 718, 720 that use the voice service. The private networks 702, 704 can agree to participate the PN-VSX 706 and sign the agreements, or deploy the smart contract.

The PN-CMS client 718 and 720 is a secure entry layer into the private network for provisioning contract voice exchange agreements when the smart contract is signed or deployed. When the smart contract is signed or deployed, the PN-CMS 716 can push the policies and rules to PN-CMS client 718 and 720 of the private networks 702, 704 based on a voice exchange membership between private networks 702, 704. The private networks 702, 704 can host such policies and rating rules.

In some implementations, the PN-VSX 706 can introduce the private network membership service permissions (PN-MSP) components 722, 724 as the mechanism to enable private network voice exchanging through a permissioned smart contract channel.

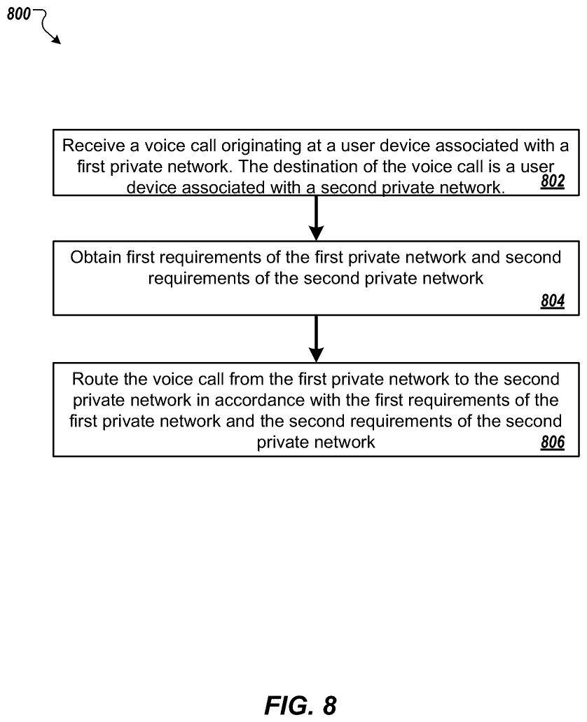

FIG. 8 is a flow diagram of an example process for providing private network voice service exchange (PN-VSX) for private networks.

At step 802, the PN-VSX receives a voice call originating at a user device associated with a first private network. The destination of the voice call is a user device associated with a second private network. The first private network and the second private network are connected over PN-VSX.

At step 804, the PN-VSX obtains first requirements of the first private network and second requirements of the second private network. The requirements of each private network can include security requirements and transport requirements of the corresponding private network.

At step 806, the PN-VSX can route the voice call from the first private network to the second private network in accordance with the first requirements of the first private network and the second requirements of the second private network.

The PN-VSX can select a call routing network for the voice call based on the requirements of each private network. For example, the call routing network can be a public switched telephone network (PSTN), a non-3GPP InterWorking Function (Untrusted & Trusted) WLAN, a IP multimedia subsystem (IMS) service network, a voice over 5G (Vo5G) network. The PN-VSX can route the voice call from the first private network to the second private network through the selected call routing network connected with the PN-VSX.

The order of steps in the process 800 described above is illustrative only, and the process 800 can be performed in different orders. In some implementations, the process 800 can include additional steps, fewer steps, or some of the steps can be divided into multiple steps.

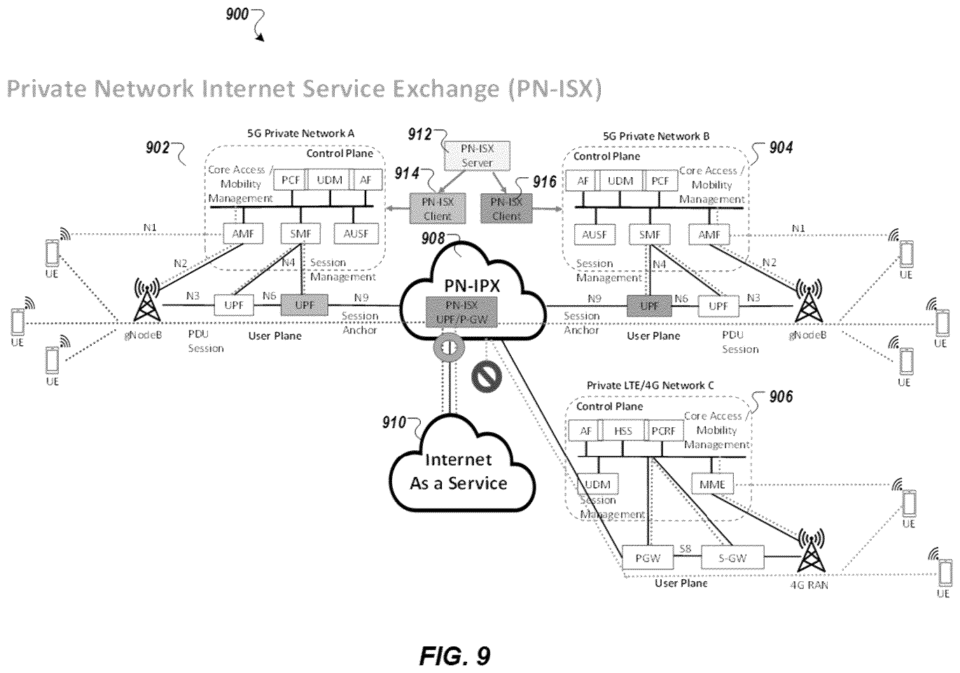

FIG. 9 is a block diagram of an example environment 900 for a private network Internet service exchange (PN-ISX) that configures Internet service parameters for private networks. Private networks often have varying requirements/functionalities that in turn requires tailoring of Internet service parameters for achieving optimal/target performance. For example, if a private network includes a network of security cameras that upload video streams to a cloud device, the bandwidth available for the private network may be configured to provide more upload capacity than download capacity. On the other hand, if a private network includes multiple display devices that stream video content, a high download capacity may be more important than a high upload capacity. In such cases, a PN-ISX device disposed in communication with a private network may configure the Internet services associated with the private network, for example, by estimating/determining the needs of the private network from information packets routed to/from the private network. For example, a PN-ISX can intercept one or more information packets from a private network, analyze the information packets to determine/estimate one or more Internet services parameters associated with the private network, and configure one or more radio access network (RAN) devices/resources accordingly.

In some implementations, the PN-ISX can be a software defined component that can control one or more RAN resources to configure the Internet services. For example, the PN-ISX can be configured to control one or more parameters of a RAN resource/device to affect Internet services to a private network. For example, the PN-ISX can be configured to control signal strength of a RAN device (e.g., to mitigate interference) or other parameters that affect a latency associated with the Internet services provided to the private network.

In some implementations, the PN-ISX can be disposed as a combination of one or more devices executing the software-defined components. The PN-ISX can be disposed within or outside a private network that it services. The location of the PN-ISX can depend on a target latency associated with controlling the RAN. For example, if the target latency is low (e.g., the Internet services parameters need to be updated frequently and fast), the PN-ISX can be disposed within a private network or proximate to a private network. On the other hand, if more latency can be tolerated, the PN-ISX may be disposed at a remote location.

Referring to FIG. 9, the example environment 900 includes a first private network, e.g., private 5G Network A 902, a second private network, e.g., private 5G Network B or private LTE Network B 904, and a third private network, e.g., private LTE/4G Network C 906. Each private network 902, 904, 906 can belong to a different enterprise or organization. For example, private 5G Network A 902 can belong to Enterprise A. Private 5G network B 904 can belong to Enterprise B. Private LTE/4G Network C 906 can belong to Enterprise C. The services and protocols for each private network 902, 904, 906 can be different. Each private network 902, 904, 906 can have its own base station (e.g., gNodeB) and other communication infrastructures. Each private network 902, 904, 906 can have its own users and user equipment (UE) that are authenticated to access the private network. The private networks 902, 904, 906 can be mobile private networks, or fixed private networks. The PN-ISX can include one or more computing devices. For example, The PN-ISX can include private network Interconnect Protocol Exchange (PN-IPX) 908 and PN-ISX server 912.

The technology described herein provides private network Internet service exchange (PN-ISX) that permissions Internet service for private networks 902, 904, 906. The PN-ISX allows private networks 902, 904, 906 that participate on the PN-IPX 908 to access Internet as a service 910.

PN-ISX can facilitate a more efficient way for private networks (e.g., 5G private networks and LTE private networks) 902, 904, 906 connect to Internet. The PN-ISX server 912 can create service agreements and settlement agreements for the private network Internet service. The PN-ISX server 912 can generate a permissioned Internet access for the private networks 902, 904, 906 participating on the PN-IPX 908. The service agreements and settlement agreements can include rules, policies, or garments for Internet service billing and charging. Based on such billing and charging policies/rules/agreements, a smart contract can be created. The users of the private networks 902, 904, 906 can be PN-ISX clients 914, 916 that use the Internet service. The private networks 902, 904, 906 can agree to participate on the PN-ISX and sign the smart contract, or deploy the smart contract.

PN-IPX 908 can include PN-ISX UPF/Packet Gateway (PGW) which is a common service for connecting private networks 902, 904, 906 to Internet based on the requirements of each private network. The requirements of each private network can include subscribed bandwidth, usage thresholds, security, and the like.

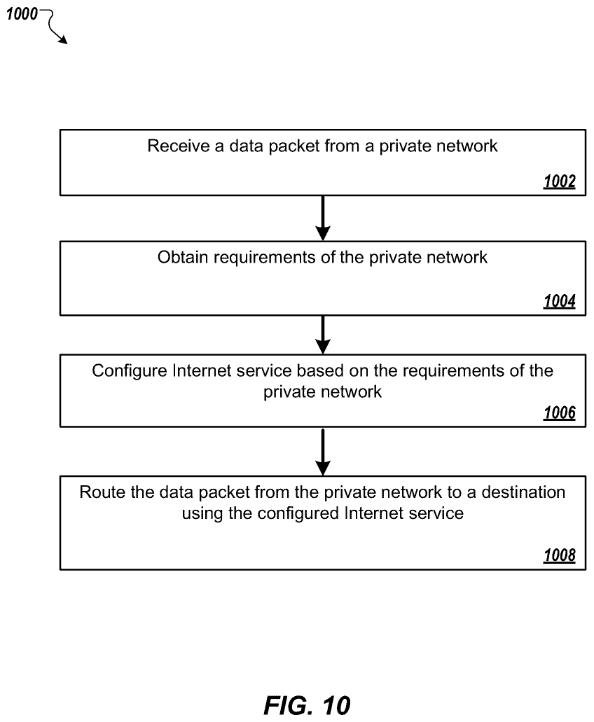

FIG. 10 is a flow diagram of an example process 1000 for providing Internet services for private networks using private network Interconnect Protocol Exchange (PN-IPX).

At step 1002, the PN-ISX UPF/PGW receives a data packet from a private network. At step 1004, the PN-ISX Server obtains requirements of the private network. The requirements of private network can include security requirements and transport requirements of the private network. At step 1006, the PN-ISX Server can configure Internet service based on the requirements of the private network via the PN-ISX Client. The PN-ISX UPF/PGW can be connected to Internet. At step 1008, the PN-ISX UPF/PGW can route the data packet from the private network to a destination using the configured Internet service.

The order of steps in the process 1000 described above is illustrative only, and the process 1000 can be performed in different orders. In some implementations, the process 1000 can include additional steps, fewer steps, or some of the steps can be divided into multiple steps.

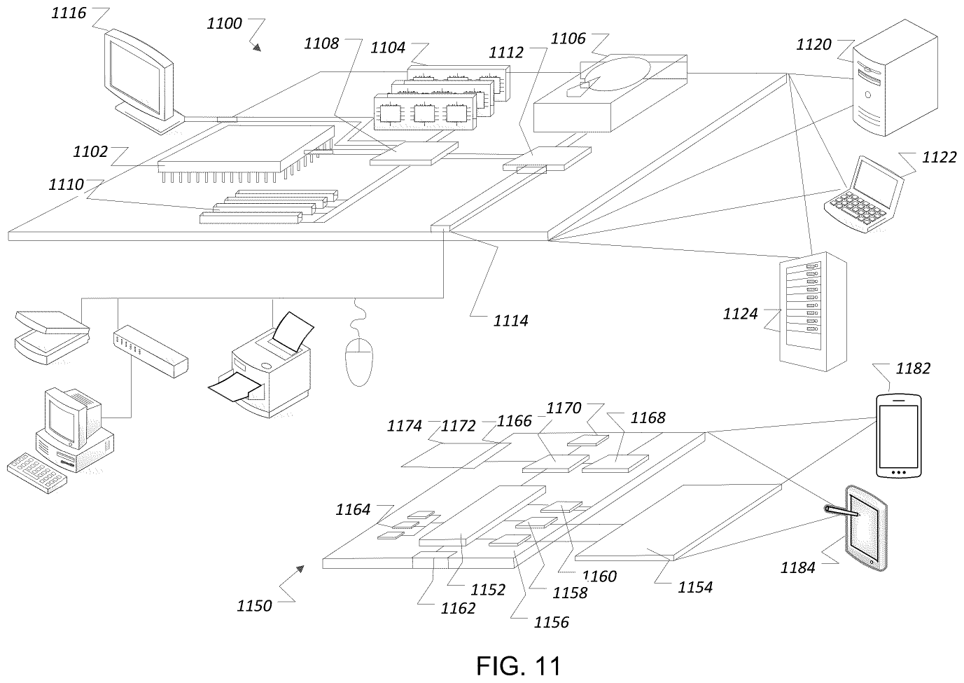

FIG. 11 shows an example of a computing device 1100 and a mobile computing device 1150 (also referred to herein as a wireless device) that are employed to execute implementations of the present disclosure. The computing device 1100 is intended to represent various forms of digital computers, such as laptops, desktops, workstations, personal digital assistants, servers, blade servers, mainframes, and other appropriate computers. The mobile computing device 1150 is intended to represent various forms of mobile devices, such as personal digital assistants, cellular telephones, smart-phones, AR devices, and other similar computing devices. The components shown here, their connections and relationships, and their functions, are meant to be examples only, and are not meant to be limiting.

The computing device 1100 includes a processor 1102, a memory 1104, a storage device 1106, a high-speed interface 1108, and a low-speed interface 1112. In some implementations, the high-speed interface 1108 connects to the memory 1104 and multiple high-speed expansion ports 1110. In some implementations, the low-speed interface 1112 connects to a low-speed expansion port 1114 and the storage device 1106. Each of the processor 1102, the memory 1104, the storage device 1106, the high-speed interface 1108, the high-speed expansion ports 1110, and the low-speed interface 1112, are interconnected using various buses, and may be mounted on a common motherboard or in other manners as appropriate. The processor 1102 can process instructions for execution within the computing device 1100, including instructions stored in the memory 1104 and/or on the storage device 1106 to display graphical information for a graphical user interface (GUI) on an external input/output device, such as a display 1116 coupled to the high-speed interface 1108. In other implementations, multiple processors and/or multiple buses may be used, as appropriate, along with multiple memories and types of memory. In addition, multiple computing devices may be connected, with each device providing portions of the necessary operations (e.g., as a server bank, a group of blade servers, or a multi-processor system).

The memory 1104 stores information within the computing device 1100. In some implementations, the memory 1104 is a volatile memory unit or units. In some implementations, the memory 1104 is a non-volatile memory unit or units. The memory 1104 may also be another form of a computer-readable medium, such as a magnetic or optical disk.

The storage device 1106 is capable of providing mass storage for the computing device 1100. In some implementations, the storage device 1106 may be or include a computer-readable medium, such as a floppy disk device, a hard disk device, an optical disk device, a tape device, a flash memory, or other similar solid-state memory device, or an array of devices, including devices in a storage area network or other configurations. Instructions can be stored in an information carrier. The instructions, when executed by one or more processing devices, such as processor 1102, perform one or more methods, such as those described above. The instructions can also be stored by one or more storage devices, such as computer-readable or machine-readable mediums, such as the memory 1104, the storage device 1106, or memory on the processor 1102.

The high-speed interface 1108 manages bandwidth-intensive operations for the computing device 1100, while the low-speed interface 1112 manages lower bandwidth-intensive operations. Such allocation of functions is an example only. In some implementations, the high-speed interface 1108 is coupled to the memory 1104, the display 1116 (e.g., through a graphics processor or accelerator), and to the high-speed expansion ports 1110, which may accept various expansion cards. In the implementation, the low-speed interface 1112 is coupled to the storage device 1106 and the low-speed expansion port 1114. The low-speed expansion port 1114, which may include various communication ports (e.g., Universal Serial Bus (USB), Bluetooth, Ethernet, wireless Ethernet) may be coupled to one or more input/output devices. Such input/output devices may include a scanner, a printing device, or a keyboard or mouse. The input/output devices may also be coupled to the low-speed expansion port 1114 through a network adapter. Such network input/output devices may include, for example, a switch or router.

The computing device 1100 may be implemented in a number of different forms, as shown in the FIG. 11. For example, it may be implemented as a standard server 1120, or multiple times in a group of such servers. In addition, it may be implemented in a personal computer such as a laptop computer 1122. It may also be implemented as part of a rack server system 1124. Alternatively, components from the computing device 1100 may be combined with other components in a mobile device, such as a mobile computing device 1150. Each of such devices may contain one or more of the computing device 1100 and the mobile computing device 1150, and an entire system may be made up of multiple computing devices communicating with each other.

The mobile computing device 1150 includes a processor 1152; a memory 1164; an input/output device, such as a display 1154; a communication interface 1166; and a transceiver 1168; among other components. The mobile computing device 1150 may also be provided with a storage device, such as a micro-drive or other device, to provide additional storage. Each of the processor 1152, the memory 1164, the display 1154, the communication interface 1166, and the transceiver 1168, are interconnected using various buses, and several of the components may be mounted on a common motherboard or in other manners as appropriate. In some implementations, the mobile computing device 1150 may include a camera device(s) (not shown).

The processor 1152 can execute instructions within the mobile computing device 1150, including instructions stored in the memory 1164. The processor 1152 may be implemented as a chipset of chips that include separate and multiple analog and digital processors. For example, the processor 1152 may be a Complex Instruction Set Computers (CISC) processor, a Reduced Instruction Set Computer (RISC) processor, or a Minimal Instruction Set Computer (MISC) processor. The processor 1152 may provide, for example, for coordination of the other components of the mobile computing device 1150, such as control of user interfaces (UIs), applications run by the mobile computing device 1150, and/or wireless communication by the mobile computing device 1150.

The processor 1152 may communicate with a user through a control interface 1158 and a display interface 1156 coupled to the display 1154. The display 1154 may be, for example, a Thin-Film-Transistor Liquid Crystal Display (TFT) display, an Organic Light Emitting Diode (OLED) display, or other appropriate display technology. The display interface 1156 may include appropriate circuitry for driving the display 1154 to present graphical and other information to a user. The control interface 1158 may receive commands from a user and convert them for submission to the processor 1152. In addition, an external interface 1162 may provide communication with the processor 1152, so as to enable near area communication of the mobile computing device 1150 with other devices. The external interface 1162 may provide, for example, for wired communication in some implementations, or for wireless communication in other implementations, and multiple interfaces may also be used.

The memory 1164 stores information within the mobile computing device 1150. The memory 1164 can be implemented as one or more of a computer-readable medium or media, a volatile memory unit or units, or a non-volatile memory unit or units. An expansion memory 1174 may also be provided and connected to the mobile computing device 1150 through an expansion interface 1172, which may include, for example, a Single in Line Memory Module (SIMM) card interface. The expansion memory 1174 may provide extra storage space for the mobile computing device 1150, or may also store applications or other information for the mobile computing device 1150. Specifically, the expansion memory 1174 may include instructions to carry out or supplement the processes described above, and may include secure information also. Thus, for example, the expansion memory 1174 may be provided as a security module for the mobile computing device 1150, and may be programmed with instructions that permit secure use of the mobile computing device 1150. In addition, secure applications may be provided via the SIMM cards, along with additional information, such as placing identifying information on the SIMM card in a non-hackable manner.

The memory may include, for example, flash memory and/or non-volatile random access memory (NVRAM), as discussed below. In some implementations, instructions are stored in an information carrier. The instructions, when executed by one or more processing devices, such as processor 1152, perform one or more methods, such as those described above. The instructions can also be stored by one or more storage devices, such as one or more computer-readable or machine-readable mediums, such as the memory 1164, the expansion memory 1174, or memory on the processor 1152. In some implementations, the instructions can be received in a propagated signal, such as, over the transceiver 1168 or the external interface 1162.

The mobile computing device 1150 may communicate wirelessly through the communication interface 1166, which may include digital signal processing circuitry where necessary. The communication interface 1166 may provide for communications under various modes or protocols, such as Global System for Mobile communications (GSM) voice calls, Short Message Service (SMS), Enhanced Messaging Service (EMS), Multimedia Messaging Service (MMS) messaging, code division multiple access (CDMA), time division multiple access (TDMA), Personal Digital Cellular (PDC), Wideband Code Division Multiple Access (WCDMA), CDMA2000, General Packet Radio Service (GPRS). Such communication may occur, for example, through the transceiver 1168 using a radio frequency. In addition, short-range communication, such as using a Bluetooth or Wi-Fi, may occur. In addition, a Global Positioning System (GPS) receiver module 1170 may provide additional navigation- and location-related wireless data to the mobile computing device 1150, which may be used as appropriate by applications running on the mobile computing device 1150.

The mobile computing device 1150 may also communicate audibly using an audio codec 1160, which may receive spoken information from a user and convert it to usable digital information. The audio codec 1160 may likewise generate audible sound for a user, such as through a speaker, e.g., in a handset of the mobile computing device 1150. Such sound may include sound from voice telephone calls, may include recorded sound (e.g., voice messages, music files, etc.) and may also include sound generated by applications operating on the mobile computing device 1150.

The mobile computing device 1150 may be implemented in a number of different forms, as shown in FIG. 11. Other implementations may include a phone device 1182 and a tablet device 1184. The mobile computing device 1150 may also be implemented as a component of a smart-phone, personal digital assistant, AR device, or other similar mobile device.

Computing device 1100 and/or 1150 can also include USB flash drives. The USB flash drives may store operating systems and other applications. The USB flash drives can include input/output components, such as a wireless transmitter or USB connector that may be inserted into a USB port of another computing device.

Although a few implementations have been described in detail above, other modifications may be made without departing from the scope of the inventive concepts described herein, and, accordingly, other implementations are within the scope of the following claims.

1. A computer-implemented method comprising:
receiving, at one or more computing devices from a first private network, information representing at least one application to be accessed by a user device associated with a second private network, the information representing the at least one application being configured in accordance with network parameters of the first private network;
transmitting the information representing the at least one application to the user device in the form of information packets configured in accordance with network parameters of the second private network; and
executing a smart contract representing application sharing agreements between the first private network and the second private network, wherein executing the smart contract includes recording a transaction in accordance with the application sharing agreements, the transaction representing the sharing of the at least one application.

2. The computer-implemented method of claim 1, comprising:
enabling a settlement between the first private network and the second private network through the executing of the smart contract.

3. The computer-implemented method of claim 1, further comprising generating a proposal for application sharing between the first and second private networks.

4. The computer-implemented method of claim 3, wherein the smart contract is generated based on the proposal for application sharing.

5. The computer-implemented method of claim 1, wherein information related to executing the smart contract is exchanged through a permissioned smart contract channel.

6. The computer-implemented method of claim 1, wherein the first private network has a first requirement for security and transport of information packets, and the second private network has a second requirement for security and transport of information packets.

7. A non-transitory computer-readable medium encoded with instructions that, when executed by one or more computers, cause the one or more computers to perform operations comprising:
receiving, from a first private network, information representing at least one application to be accessed by a user device associated with a second private network, the information representing the at least one application being configured in accordance with network parameters of the first private network;
transmitting the information representing the at least one application to the user device in the form of information packets configured in accordance with network parameters of the second private network; and
executing a smart contract representing application sharing agreements between the first private network and the second private network, wherein executing the smart contract includes recording a transaction in accordance with the application sharing agreements, the transaction representing the sharing of the at least one application.

8. The non-transitory computer-readable medium of claim 7, wherein the operations comprise:
enabling a settlement between the first private network and the second private network through the executing of the smart contract.

9. The non-transitory computer-readable medium of claim 7, wherein the operations comprise:
generating a proposal for application sharing between the first and second private networks.

10. The non-transitory computer-readable medium of claim 9, wherein the smart contract is generated based on the proposal for application sharing.

11. The non-transitory computer-readable medium of claim 7, wherein information related to executing the smart contract is exchanged through a permissioned smart contract channel.

12. The non-transitory computer-readable medium of claim 7, wherein the first private network has a first requirement for security and transport of information packets, and the second private network has a second requirement for security and transport of information packets.

13. A system comprising one or more computers and one or more storage devices on which are stored instructions that are operable, when executed by the one or more computers, to cause the one or more computers to perform operations comprising:
receiving, from a first private network, information representing at least one application to be accessed by a user device associated with a second private network, the information representing the at least one application being configured in accordance with network parameters of the first private network;
transmitting the information representing the at least one application to the user device in the form of information packets configured in accordance with network parameters of the second private network; and
executing a smart contract representing application sharing agreements between the first private network and the second private network, wherein executing the smart contract includes recording a transaction in accordance with the application sharing agreements, the transaction representing the sharing of the at least one application.

14. The system of claim 13, wherein the operations comprise:
enabling a settlement between the first private network and the second private network through the executing of the smart contract.

15. The system of claim 13, wherein the operations comprise:
generating a proposal for application sharing between the first and second private networks.

16. The system of claim 15, wherein the smart contract is generated based on the proposal for application sharing.

17. The system of claim 13, wherein information related to executing the smart contract is exchanged through a permissioned smart contract channel.

18. The system of claim 13, wherein the first private network has a first requirement for security and transport of information packets, and the second private network has a second requirement for security and transport of information packets.
